(19) United States
(12) Patent Application Publication
(10) Pub. No.: US 2016/0125476 A1
(43) Pub. Date: May 5, 2016

(54) System, device, and method for selfie-enabled product promotion

(71) Applicant: Paula Stewart, San Francisco, CA (US)

(72) Inventor: Paula Stewart, San Francisco, CA (US)

(21) Appl. No.: 14/531,927

(22) Filed: Nov. 3, 2014

(51) Int. Cl. G06Q 30/02

(52) U.S. Cl. CPC G06Q 30/0276

(57) ABSTRACT

A system for selfie-enabled product promotion includes a selfie promotion server, including a product storage, a selfie promotion storage, a social network manager, and a selfie promotion manager; and a selfie promotion device, including a promotion designer, a product selector, and a selfie capture component, such that the selfie promotion device allows a user to capture a selfie, and create a selfie promotion campaign, including the selfie associated with a product, such that the selfie promotion server posts the selfie promotion campaign on a social network. The selfie promotion device further includes a processor, a memory, and an input/output. Also disclosed is a method for selfie-enabled product promotion, including selecting a product, capturing a selfie, promoting the selfie, and selling the product.

### CROSS-REFERENCE TO RELATED APPLICATIONS

N/A

### FIELD OF THE INVENTION

The present invention relates generally to the field of social media, and more particularly to methods and systems for capturing and associating selfies with brand promotion in a social network.

### BACKGROUND OF THE INVENTION

Selfie, which are self-photographs usually taken with an extended arm holding a hand-held digital camera or smart phone, have become a part of pop-culture in recent years.

Selfies are often shared on social networks, and some users post selfies on a daily basis on social networks, such as Instagram™ or Facebook. Followers or friends can then comment on, like, or rate the selfies, and engage in other common social media interactions.

However, there are no available systems, applications, or devices that enable a user to promote or sell a brand or product in conjunction with the sharing of a selfie, and while selfies are increasingly used by celebrities as a part of ongoing communication with fans, these selfies are not associated with any systemic capabilities for brand or product promotion.

As such, considering the foregoing, it may be appreciated that there continues to be a need for novel and improved devices and methods for managing posting of selfies on a social network in conjunction with promotion and sales of products or brands.

### SUMMARY OF THE INVENTION

The foregoing needs are met, to a great extent, by the present invention, wherein in aspects of this invention, enhancements are provided to the existing models for sharing and posting of selfies and social network.

In an aspect, a system for selfie-enabled product promotion enables users to take pictures of themselves, associate the pictures, also known as selfies, with a brand or product, and post the selfies with the brand or product association, in the form of a selfie promotion, on a social network.

In an aspect a system for selfie-enabled product promotion can include:
a) a selfie promotion server; and
b) a selfie promotion device,
such that the selfie device communicates with the selfie server via a network, and such that a user can create and store a selfie promotion via the selfie promotion devices, such that the selfie promotion is stored on the selfie promotion server, such that the selfie promotion server publishes the selfie promotion on a social network system.

In related aspects, users can use the selfie promotion device to share, rate, and comment on selfie promotions.

In related aspects, a promotion type of a selfie promotion can include:
a. A single product promotion, wherein the selfie promotion includes one product only;
b. A compare promotion, wherein the selfie promotion compares at least 2 products;
c. A challenge promotion, wherein a selfie promotion with one product challenges followers to post selfies with similar products;
d. A product story promotion, the selfie promotion includes a product, which can be associated with two or more selfies, such that the each selfie displays an element of an evolving story associated with the product.

In related aspects, a product category of a product in selfie promotion can include a physical product; a service; a person, such as a celebrity or other public persona; a place, including a country, region, or city, etc.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for selfie-enabled product promotion, according to an embodiment of the invention.

FIG. 2 is a schematic diagram illustrating a selfie promotion server, according to an embodiment of the invention.

FIG. 3 is a schematic diagram illustrating a selfie promotion device, according to an embodiment of the invention.

FIG. 4 is a schematic diagram illustrating a selfie promotion campaign data structure, according to an embodiment of the invention.

FIG. 5 is a flowchart illustrating steps that may be followed, in accordance with one embodiment of a method or process of selfie-enabled product promotion.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

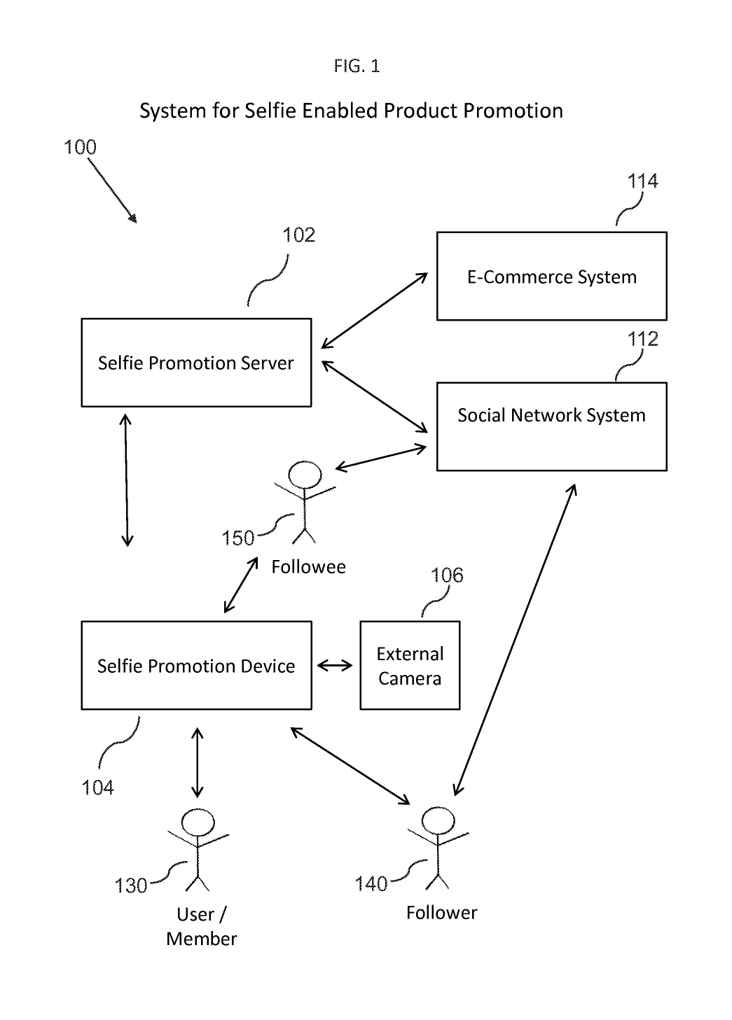

In the following, we describe the structure of an embodiment of a system for selfie-enabled product promotion 100 with reference to FIG. 1, in such manner that like reference numerals refer to like components throughout; a convention that we shall employ for the remainder of this specification.

In an embodiment a system for selfie-enabled product promotion 100 can include:
c) a selfie promotion server 102; and
d) a selfie promotion device 104, such that the selfie device 104 communicates with the selfie server 102 via a network;
wherein the selfie promotion device 104 can be configured to allow a user 130 to capture a selfie, and create a selfie promotion campaign, which includes the selfie in association with a product, such that the selfie promotion server 102 can be configured to store the selfie promotion campaign, in communication with the selfie promotion device, and post the selfie promotion campaign on a social network 112.

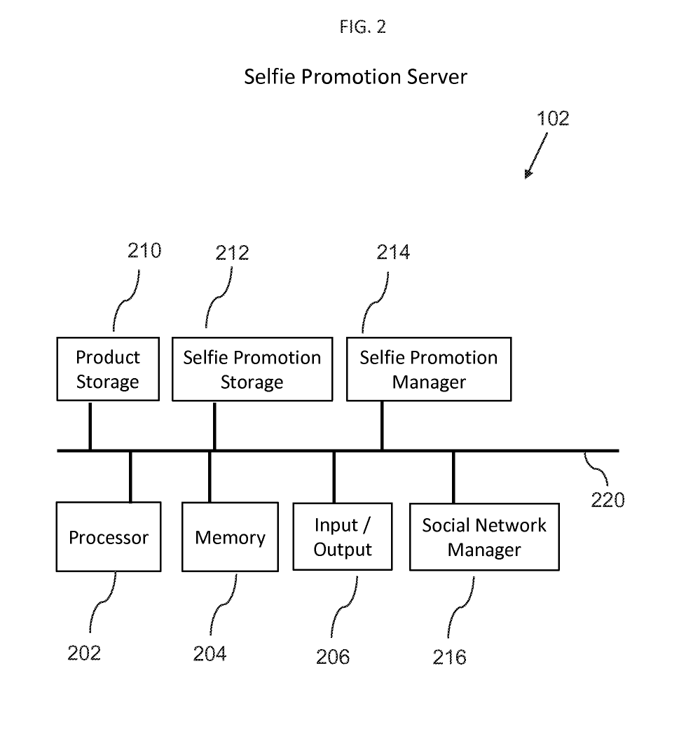

In a related embodiment, as illustrated in FIG. 2, a selfie promotion server 102 can include:
a. A processor 202;
b. A non-transitory memory 204;
c. An input/output component 206;
d. A product storage 210, which saves, stores, and retrieves product information from the memory 204 via the processor 202, wherein the product information includes product descriptions and photographs;
e. A selfie promotion storage 212, which saves, stores and retrieves selfie promotions from the memory 204 via the processor 202, wherein a selfie promotion includes product information for at least one selected product, which is associated with at least one selfie picture;
f. A selfie promotion manager 214, which can retrieve, process, and save a selfie promotion in communication with the selfie promotion storage 212; and
g. A social network manager 216, which can be configured to retrieve, process, and save a selfie promotion in communication with the selfie promotion manager 214, and can create social media postings on a social network system 112; all connected via
h. A data bus 220.

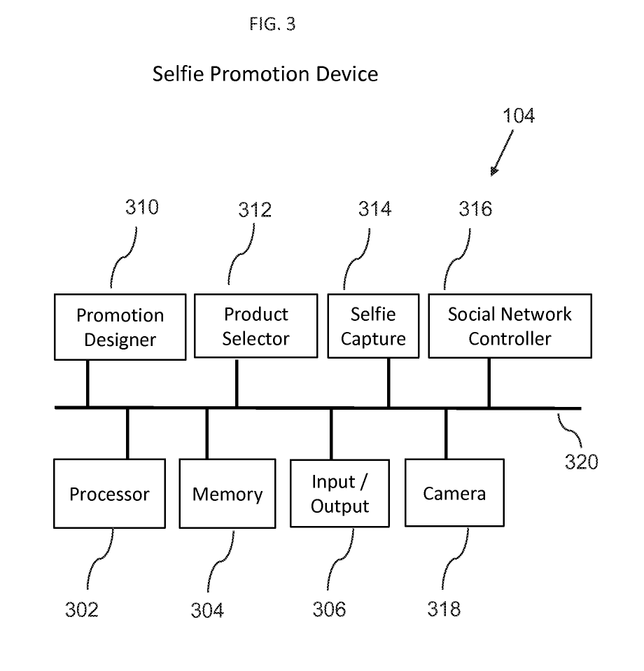

In a related embodiment, as illustrated in FIG. 3, a selfie promotion device 104 can include:
a. A processor 302;
b. A non-transitory memory 304;
c. An input/output 306;
d. A promotion designer 310;
e. A product selector 312;
f. A selfie capture component 314; and
g. A device camera 318; all connected via
h. A data bus 320;
wherein the selfie capture component is configured to manage capture of a selfie, i.e. a self-photograph, in communication with the device camera 318 or an external camera 106;
wherein the product selector 312 is configured to allow a user 130 to select a product for promotion from the product storage 210 of the selfie promotion server 102; and
wherein the promotion designer 310 is configured to allow a user 130 to edit a selfie promotion campaign, wherein the selfie promotion campaign includes the selfie such that the selfie promotion campaign is stored by the selfie promotion storage 212 of the selfie promotion server 102, for distribution on a social network system 112.

In related embodiments, the selfie promotion device 104 can include configurations as:
a. A web application, executing in a Web browser;
b. A tablet app, executing on a tablet device, such as for example an Android or iOS tablet device;
c. A mobile app, executing on a mobile device, such as for example an Android phone or iPhone, or any wearable mobile device;
d. A desktop application, executing on a personal computer, or similar device;
e. An embedded application, executing on a processing device, such as for example a smart TV, a game console or other system.

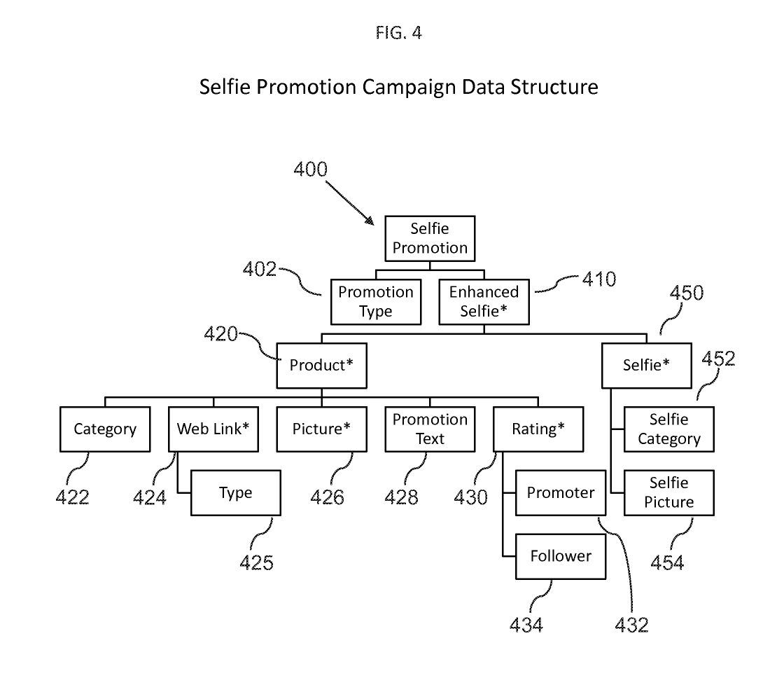

In a related embodiment, as illustrated in FIG. 4, a selfie promotion campaign 400 data structure can include:

a. A promotion type 402;

b. An enhanced selfie 410; including:
i. At least one product 420, including:
   1. A product category 422;
   2. At least one product web link 424;
      a. A web link type 425;
   3. Optionally, at least one product picture 426;
   4. A promotion text 428, which is a text describing and promoting the product 420; and
   5. A rating 430; which can be a numerical rating
      a. Promoter rating 432; which is a rating of the user 130, who is promoting the product;
      b. Follower ratings 434, which can further be aggregated to an aggregate follower rating;
ii. At least one selfie 450, including:
   1. A selfie category 452;
   2. A selfie picture 454;

In related embodiments, a selfie picture 454; is a picture that is taken by the user 130, with a hand-held self-promotion device 104, which can for example be a smart phone, or with another external camera 106, such that the picture contains a self-portrait of the user 130.

In a further related embodiment, the selfie picture 454, can include a self-portrait of the user wearing or otherwise using a product 420.

In a related embodiment, a promotion type 402 can include:
a. A single product promotion, which denotes that the selfie promotion campaign 400 includes one product 420 only, which can be associated with one or more selfies 450;
b. A compare promotion, which denotes that the selfie promotion campaign 400 includes two or more products 420, which can each be associated with one or more selfies 450, such that the purpose is to compare the products 420, by promoter and follower ratings 432 434, whereby a user 130 for example can compare different clothing, hair, or make up, and a business user 130 can determine which product variations are preferred amongst the customer followers 140;
c. A challenge promotion, which denotes that the selfie promotion campaign 400 includes at least one original product 420, which can be associated with at least one selfie 450, such that the purpose is to challenge followers to post selfies with similar products 420, such that the original product 420 and the similar products 420 can be compared by promoter and follower ratings 432 434;
d. A product story promotion, which denotes that the selfie promotion campaign 400 includes a product 420, which can be associated with two or more selfies 450, such that each selfie 450 illustrates an element of an evolving story associated with the product.

In a related embodiment, a product category 422 can include:
a. A physical product;
b. A service;
c. A person, such as a celebrity or other public persona;
d. A place, including a country, region, county, city, etc.;
e. Any other category of objects that can be subject to a promotion in order to gain followers, sales, publicity, etc; or
f. Combinations thereof.

In a related embodiment, a product web link 424 is a uniform resource locator, which can further include:

a. a web link type 425, including
i. a product information type, such that the product web link 424 provides a link to information about the product;
ii. a product shopping type, such that the product web link 424 provides a link to an item for sale in an e-commerce system 114;
iii. a social media type, such that the product web link 424 provides a link to an object in a social network system 112, such as a posting or member; or
iv. an image type, such that the product web link 424 provides a link to an image of the product, or the image is otherwise associated with the product, such as showing use of the product, or directly or indirectly referencing the product.

In a related example embodiment, tabs of a main window in the graphical user interface for the selfie promotion device 104 can include:
a. My Pictures, where users 130 can store their selfie pictures 454. They can create folders and save their pictures categorically, for easy viewing at a later time;
b. Followers, which can contain a list of all the followers 140 that are following the user 130. The followers 140 can view the profile, selfies 450, and selfie promotion campaigns 400, which are associated with the user 130.
c. Follows, which can contain a list of followees 150 that the user 130 is following. The user 130 gets access to their images and profile information.
d. Capture Selfie, which enables the user 130 to take a selfie picture 454, with a camera.
e. Upload Selfie, which enables the user 130 to upload his/her selfie picture 454 to his/her profile once he/she takes a selfie;
f. Top Selfies, which shows highest ranked selfie pictures 454 for the user 130;
g. Circle Top, which shows highest ranked selfie pictures 454 of followers 140 and follows;
h. Search, wherein the user 130 can search other users, using search criteria such as age or gender. The user 130 can then select identified users/followees 150 to follow;
i. Profile, wherein the user 130 can upload selfie pictures 454, edit them and update them;
j. Edit Selfie Promotion, wherein the user 130 can edit a selfie promotion, including selecting and editing products 420 and selfies 450.
k. Rate Selfie, wherein the user 130 can send followers a request for rating a selfie promotion campaign 400.

In a related embodiment, the selfie promotion device 104 can further include a social network controller 316, such that the social network controller 316 is configured to allow a user 130 to interact with a social network system 112, in communication with the social network manager 216 of the selfie promotion server.

In a related embodiment, a user 130 can receive notifications via the social network controller 316 of the selfie promotion device 104, such that notifications can include:
a. Direct comment notification, issued when a follower 140 of the user 130 comments on a selfie promotion campaign 400 of the user 130;
b. Direct rating notification, issued when a follower 140 of the user 130 rates a selfie promotion campaign 400 of the user 130;
c. Indirect comment notification, issued when a followee 150, followed by the user 130, receives a comment on a selfie promotion campaign 400 of the followee 150;
d. Indirect rating notification, issued when a followee 150, followed by the user 130, receives a rating of a selfie promotion campaign 400 of the followee 150;

In related embodiments, selfie pictures 454 can become social referrals for a brand or product 420, and customers can become brand ambassadors via the social referrals.

In related embodiments, a user 130 can be a celebrity or public persona, such that the brand of the user 130 is associated with and strengthens the brand of a product 420, via a selfie promotion campaign 400.

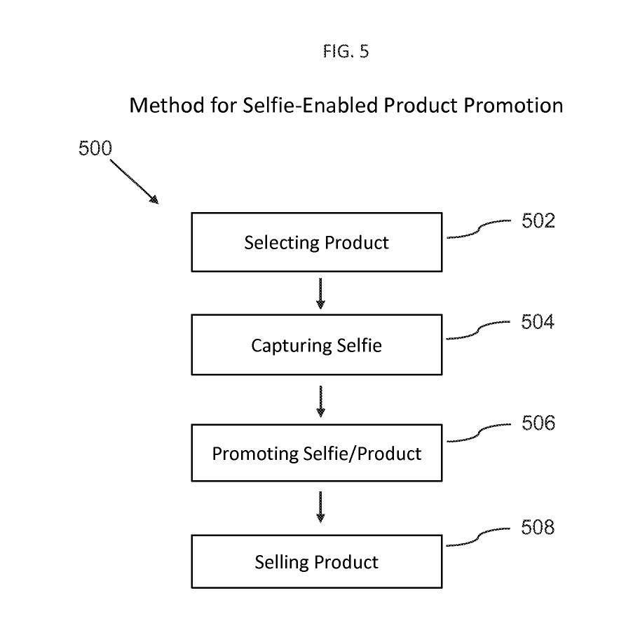

In an embodiment, as illustrated in FIG. 5, a method for selfie-enabled product promotion 500 can include:
a. Selecting a product 502; wherein a user selects a product from a product storage, stored in a non-transitory memory;
b. Capturing a selfie 504, wherein the selfie is a self-photograph that is captured with a camera held by a user, such that the selfie includes the product, for example by including use or display of the product;
c. Promoting the selfie 506, wherein a selfie promotion campaign, which further includes the selfie in association with the product, is promoted on a social network 112, wherein the promotion can include posting the selfie with web links that contain information or connect the user to an e-commerce system 114;

In a related embodiment, the method for selfie-enabled product promotion 500 can further include:
d. Selling the product 508, wherein a follower of the user 130 in the social network completes a sales transaction in the e-commerce system 114.

It shall be understood that an executing instance of an embodiment of the system for selfie-enabled product promotion 100, as shown in FIG. 1, can include a plurality of selfie promotion devices 104, which are each tied to one or more users 130, and one or more followers 140.

An executing instance of an embodiment of the system for selfie-enabled product promotion 100, as shown in FIG. 1, can similarly include a plurality of selfie promotion servers 102.

FIGS. 1, 2, and 3 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for selfie-enabled product promotion 100, including the selfie promotion server 102, and the selfie promotion device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the selfie promotion server 102 and the selfie promotion device 104 are to be interpreted in the most general manner.

For example, the processors 202 302, can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the selfie promotion server 102 and the selfie promotion device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the selfie promotion device 104 communicates with the selfie promotion server 102 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

In a related embodiment, the selfie promotion server 102 communicates with a social network system 112 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

In a related embodiment, the selfie promotion server 102 communicates with an e-commerce system 114 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the selfie promotion server 102 and the selfie promotion device 104. The components of the selfie promotion server 102 can be distributed over a plurality of physical, logical, or virtual servers. Parts or all of the components of the selfie promotion device 104 can be configured to operate in the selfie promotion server 102, whereby the selfie promotion device 104 for example can function as a thin client, performing only graphical user interface presentation and input/output functions. Alternatively, parts or all of the components of the selfie promotion server 102 can be configured to operate in the selfie promotion device 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for selfie-enabled product promotion, comprising:
a. a selfie promotion server; and
b. a selfie promotion device, such that the selfie device communicates with the selfie server via a network;
wherein the selfie promotion device is configured to allow a user to capture a selfie, and create a selfie promotion campaign, which includes the selfie in association with a product,
such that the selfie promotion server is configured to store the selfie promotion campaign, in communication with the selfie promotion device, and post the selfie promotion campaign on a social network.

2. The system for selfie-enabled product promotion of claim 1, wherein the selfie promotion server further comprises:
a. a processor;
b. a non-transitory memory;
c. an input/output component;
d. a product storage, which saves, stores, and retrieves product information from the memory via the processor;
e. a selfie promotion storage, which saves, stores and retrieves selfie promotions from the memory via the processor, wherein a selfie promotion includes product information for at least one selected product, which is associated with a least one selfie picture;
f. a selfie promotion manager, which retrieves, processes, and saves the selfie promotion in communication with the selfie promotion storage;
g. a social network manager, which is configured to retrieve, process, and save a selfie promotion in communication with the selfie promotion manager, and create social media postings on a social network system; and
h. a data bus, which connects components of the selfie promotion server.

3. The system for selfie-enabled product promotion of claim 1, wherein the selfie promotion device further comprises:
a. a processor;
b. a non-transitory memory;
c. an input/output;
d. a promotion designer;
e. a product selector; and
f. a selfie capture component; all connected via
g. a data bus;
wherein the selfie capture component is configured to manage capture of a selfie in communication with a camera;
wherein the product selector is configured to allow the user to select the product for promotion from the product storage of the selfie promotion server; and
wherein the promotion designer is configured to allow the user to edit the selfie promotion campaign, such that the selfie promotion campaign includes the product and the selfie, and such that the selfie promotion campaign is stored by the selfie promotion storage of the selfie promotion server, for distribution on a social network system.

4. The system for selfie-enabled product promotion of claim 1, wherein the selfie promotion device is configured as a mobile app that is executing on a mobile device.

5. The system for selfie-enabled product promotion of claim 1, wherein the selfie promotion campaign further comprises a promotion type, such that the promotion type is selected from the group consisting of:
a. a single product promotion, which denotes that the selfie promotion campaign includes one product only, which is associated with one or more selfies;
b. a compare promotion, which denotes that the selfie promotion campaign includes two or more products, which are each associated with one or more selfies, such that the purpose of the selfie promotion campaign is to compare the products, by promoter and follower ratings, whereby a user determines which product is preferred by followers;
c. a challenge promotion, which denotes that the selfie promotion campaign includes at least one original product, which is associated with at least one selfie, such that the purpose is to challenge followers to post selfies with similar products, such that the original product and the similar products are compared by promoter and follower ratings; and
d. a product story promotion, which denotes that the selfie promotion campaign includes a product, which is associated with two or more selfies, such that each selfie illustrates an element of an evolving story associated with the product.

6. The system for selfie-enabled product promotion of claim 1, wherein the selfie promotion campaign further comprises a product category, such that the product category is selected from the group consisting of: a physical product, a service, a person, a place, an object, and combinations thereof.

7. The system for selfie-enabled product promotion of claim 1, wherein the selfie promotion campaign further comprises a product web link and a web link type, such that the product web link type is selected from the group consisting of: a product information type, a product shopping type, a social media type, and an image type.

8. The system for selfie-enabled product promotion of claim 3, wherein the selfie promotion device further comprises a social network controller, such that the social network controller is configured to allow the user to interact with the social network system, in communication via the selfie promotion server.

9. A selfie promotion device, comprising:
a. a processor;
b. a non-transitory memory;
c. an input/output;
d. a promotion designer;
e. a product selector; and
f. a selfie capture component; all connected via
g. a data bus;
wherein the selfie capture component is configured to manage capture of a selfie in communication with a camera;
wherein the product selector is configured to allow a user to select a product for promotion; and
wherein the promotion designer is configured to allow the user to edit a selfie promotion campaign, such that the selfie promotion campaign includes the product and the selfie, and such that the selfie promotion campaign is stored on a selfie promotion server, for distribution on a social network system.

10. The selfie promotion device of claim 9, wherein the selfie promotion device is configured as a mobile app that is executing on a mobile device.

11. The selfie promotion device of claim 9, wherein the selfie promotion campaign further comprises a promotion type, such that the promotion type is selected from the group consisting of:
a. a single product promotion, which denotes that the selfie promotion campaign includes one product only, which is associated with one or more selfies;
b. a compare promotion, which denotes that the selfie promotion campaign includes two or more products, which are each associated with one or more selfies, such that the purpose of the selfie promotion campaign is to compare the products, by promoter and follower ratings, whereby a user determines which product is preferred by followers;
c. a challenge promotion, which denotes that the selfie promotion campaign includes at least one original product, which is associated with at least one selfie, such that the purpose is to challenge followers to post selfies with similar products, such that the original product and the similar products are compared by promoter and follower ratings; and
d. a product story promotion, which denotes that the selfie promotion campaign includes a product, which is associated with two or more selfies, such that each selfie illustrates an element of an evolving story associated with the product.

12. The selfie promotion device of claim 9, wherein the selfie promotion campaign further comprises a product category, such that the product category is selected from the group consisting of: a physical product, a service, a person, a place, an object, and combinations thereof.

13. The selfie promotion device of claim 9, wherein the selfie promotion campaign further comprises a product web link and a web link type, such that the product web link type is selected from the group consisting of: a product information type, a product shopping type, a social media type, and an image type.

14. The selfie promotion device of claim 9, further comprising a social network controller, such that the social network controller is configured to allow the user to interact with the social network system.

15. A computer-enabled method for selfie-enabled product promotion, comprising:
a. selecting a product, wherein a user selects a product from a product storage, stored in a non-transitory memory;
b. capturing a selfie, wherein the selfie is a self-photograph that is captured with a camera held by the user, such that the selfie includes the product;
c. promoting the selfie, wherein a selfie promotion campaign, which further includes the selfie in association with the product, is promoted on a social network, wherein the promotion includes posting the selfie with web links.

16. The computer-enabled method for selfie-enabled product promotion of claim 15, further comprising:
d. selling the product, wherein a follower of the user in the social network completes a sales transaction in an e-commerce system.

17. The computer-enabled method for selfie-enabled product promotion of claim 15, wherein the user takes the selfie with a mobile app that is executing on a mobile device.

18. The computer-enabled method for selfie-enabled product promotion of claim 15, wherein the selfie promotion campaign further comprises a promotion type, such that the promotion type is selected from the group consisting of:
a. a single product promotion, which denotes that the selfie promotion campaign includes one product only, which is associated with one or more selfies;
b. a compare promotion, which denotes that the selfie promotion campaign includes two or more products, which are each associated with one or more selfies, such that the purpose of the selfie promotion campaign is to compare the products, by promoter and follower ratings, whereby a user determines which product is preferred by followers;
c. a challenge promotion, which denotes that the selfie promotion campaign includes at least one original product, which is associated with at least one selfie, such that the purpose is to challenge followers to post selfies with similar products, such that the original product and the similar products are compared by promoter and follower ratings; and
d. a product story promotion, which denotes that the selfie promotion campaign includes a product, which is associated with two or more selfies, such that each selfie illustrates an element of an evolving story associated with the product.

19. The computer-enabled method for selfie-enabled product promotion of claim 15, wherein the selfie promotion campaign further comprises a product category, such that the product category is selected from the group consisting of: a physical product, a service, a person, a place, an object, and combinations thereof.

20. The computer-enabled method for selfie-enabled product promotion of claim 15, wherein the selfie promotion campaign further comprises a product web link and a web link type, such that the product web link type is selected from the group consisting of: a product information type, a product shopping type, a social media type, and an image type.
